(19) United States
(12) Patent Application Publication
(10) Pub. No.: US 2012/0213480 A1
(43) Pub. Date: Aug. 23, 2012

(54) CO-PACKAGED SEMICONDUCTOR OPTICAL DEVICES

(76) Inventors: Nadhum K. Zayer, Newton Abbot (GB); Barrie Flintham, Totnes (GB); Ian Peter McClean, Brixham (GB)

(21) Appl. No.: 13/501,359

(22) PCT Filed: Aug. 2, 2010
(86) PCT No.: PCT/IB10/01909

§ 371 Date: May 9, 2012

Related U.S. Application Data
(60) Provisional application No. 61/250,677, filed on Oct. 12, 2009.

(51) Int. Cl. G02B 6/36; B23P 11/00

(52) U.S. Cl. 385/89; 29/428

(57) ABSTRACT

A plurality of semiconductor optical devices has a common package and common supporting structures and controls. The semiconductor optical devices are typically semiconductor lasers or photodiodes and are designed for operation independently of each other or in a coordinated way. In one embodiment, co-packaged semiconductor lasers may be used individually to drive each of the amplification stages of a multi-stage optical amplifier. The optical fibers connecting to the optical devices share a common port and are aligned prior to engagement with the light output/input of the co-packaged semiconductor optical devices.

### RELATED APPLICATION DATA

This application claims the benefit of U.S. Provisional Patent Application No. 61/250,677 filed Oct. 12, 2009 which is incorporated herein by reference in its entirety.

### TECHNICAL FIELD

The present invention relates generally to the co-packaging of semiconductor optical devices, and in particular to the co-packaging of semiconductor lasers and/or semiconductor photodiodes for use with optical amplifiers.

### BACKGROUND

Packaged semiconductor optical devices such as pump lasers are well established products. They are typically manufactured in large quantities with output wavelengths typically in the vicinity of 980 nm or 1480 nm, depending upon the desired application. Each semiconductor optical device is typically packaged into its own housing and hermetically sealed. The packaged semiconductor optical device may be optically coupled to an external optical device such as an optical amplifier. This coupling is typically achieved by an optical fiber that passes through a port on a wall of the housing. In order to achieve and maintain the hermetic seal of the housing, particular care is taken at the port.

FIG. 1 illustrates a package 100 including a conventional assembly for optically coupling a semiconductor optical device 12 to an external optical device such as an optical amplifier (not shown). As illustrated, the semiconductor optical device 12 is packaged within a housing 14 and rests upon a carrier 16 which in turn may be supported upon a thermo-electric cooler (TEC) 18. A ferrule 110 is arranged such that it passes through the port 20 of the wall 14a. The ferrule 110 is fixedly attached, e.g., soldered to the wall 14a. With additional reference to FIG. 2, an optical fiber 26 is arranged such that it passes through the ferrule 110. The optical fiber 26 is fixedly attached to the ferrule 110 using low melting point glass 28 (or solder in the case of a metalized fiber) which also serves as hermetic seal. An epoxy resin 30 fills an interior portion of the ferrule 110. The optical fiber 26 extends into the housing 14 and a portion of the fiber proximate an end face 32 of the optical fiber 26 is fixedly attached to a fixing point 22. A curve is present in the optical fiber 26 to allow for stress relief at the end face 32. The end face 32 of the optical fiber 26 is formed as a lens and is arranged at a longitudinal and rotational position relative to an output of the semiconductor optical device 12 such that an optimized amount of light emitted from the semiconductor optical device 12 may be coupled into the optical fiber 26.

Prior to assembly of the package 100, the optical fiber 26 is passed through the ferrule 110 and fixed to the ferrule 110 via the low melting point glass 28, solder, or epoxy resin 30. The package 100 is assembled by disposing the semiconductor optical device 12, carrier 16, and optional TEC 18 in the housing, and by inserting the combined ferrule 110 and optical fiber 26 through the port 20 such that the ferrule is disposed in the port 20. The optical fiber 26 is rotationally adjusted by rotating the ferrule 110 so that the optical fiber 26 that is fixed thereto rotates until the end face 32 of the optical fiber 26 is rotationally aligned with the semiconductor optical device 12. The optical fiber 26 may also be longitudinally adjusted with respect to the semiconductor optical device 12, for example, by adjusting the ferrule 110 and/or by adjusting the amount of curve in the optical fiber 26. Alignment of the end face 32 of the optical fiber 26 with respect to the semiconductor optical device 12 allows for optimized optical coupling therebetween. When correctly aligned, the portion of the optical fiber 26 proximate the end face 32 is fixed in place with low melting point glass 28, solder, or epoxy resin 30 at the fixing point 22. The ferrule 110 is also fixedly attached, e.g., soldered, to the wall 14a.

Many multi-stage optical amplifiers require more than one pump laser. Simply using a single pump laser split between two amplifier stages often results in insufficient power output. Control of each stage of the amplifier is also improved by direct control of its own pump laser. Furthermore, some amplifiers require the use of different wavelengths for the different stages of the amplifier. Hence many optical amplifiers are pumped by a plurality of separately packaged optical devices such as that illustrated in FIGS. 1 and 2.

At the same time there is a need to reduce the size (the so-called footprint) and the cost of packaged semiconductor optical devices. In many cases simply placing two semiconductor optical devices in one package does not present an adequate solution. It has not been possible to use a single optical port for multiple optical devices where precise fiber alignment is necessary because assembly of the conventional package 100 includes insertion of the combined ferrule 110 and optical fiber 26 through the port 14a and the active rotational alignment thereof until the maximum light is transmitted or received. Accordingly, the footprint of the packaged semiconductor optical device is not reduced and the cost of manufacture is reduced by little, as the combination of two semiconductor optical devices in one package yields the same number of output ports as semiconductor optical devices. In addition, the effects of thermal and other radiative cross-talk or interference between semiconductor optical devices have resulted in the individual packaging of such devices.

### SUMMARY OF INVENTION

There present invention provides the advantage of putting more than one semiconductor optical device (e.g., a semiconductor laser and/or semiconductor photodiode) into a single package while overcoming the above-described disadvantages of conventional packaged semiconductor optical devices. In this invention, multiple semiconductor optical devices can be packaged in a package having little difference in size from a package containing one semiconductor optical device. The invention is applicable to high power laser applications where a small foot print and economy of design are required. This invention overcomes problems with co-packaging and provides for a means of multiple fibers (at least two) sharing one fiber port.

In accordance with one aspect of the invention, a semiconductor optical device package includes: a plurality of semiconductor optical devices disposed within a housing; a port arranged on a wall of the housing; a ferrule fixedly disposed in the optical outlet port; and a plurality of optical fibers passed through and fixedly attached to the ferrule, the plurality of optical fibers being respectively optically coupled to the plurality of semiconductor optical devices.

According to one embodiment, optical axes of the plurality of optical fibers are rotationally aligned with respect to each other. According to another embodiment, a tolerance on the rotational alignment between the optical axes of the plurality of optical fibers is about +/−4°.

According to another embodiment, optical axes of the plurality of optical fibers are laterally aligned with respect to each other. According to another embodiment, a tolerance on the lateral alignment between the optical axes of the plurality of optical fibers is less than about 2 μm.

According to another embodiment, the plurality of optical fibers are fixedly attached to the ferrule using at least one of low melt point glass, solder, and epoxy resin.

According to another embodiment, the plurality of optical fibers optically couple the plurality of semiconductor optical devices to at least one of an EDFA amplifier and a Raman amplifier.

According to another embodiment, the semiconductor optical devices are at least one of semiconductor lasers, semiconductor photodiodes, and at least one semiconductor laser and at least one semiconductor photodiode.

According to another embodiment, at least one of the semiconductor optical devices emits light at a wavelength of at least one of about 980 nm and about 1480 nm.

In accordance with another aspect of the invention, a ferrule for being fixedly disposed in the optical outlet port of a semiconductor optical device package includes: an orifice through which a plurality of optical fibers pass through, the plurality of optical fibers being fixedly attached to the ferrule.

In accordance with another aspect of the invention, a method of manufacturing semiconductor optical device package includes: inserting a ferrule and a plurality of optical fibers passed through and fixedly attached to the ferrule through a port arranged on a wall of a housing; optically coupling the plurality of optical fibers to a plurality of semiconductor optical devices disposed within the housing; and fixedly attaching the ferrule to the wall of the housing.

According to one embodiment, the plurality of optical fibers are passed through and fixedly attached to the ferrule prior to the step of inserting the ferrule and the plurality of optical fibers through the port. According to another embodiment, optical axes of the plurality of optical fibers are rotationally aligned with respect to each other prior to the step of being fixedly attached to the ferrule. According to another embodiment, optical axes of the plurality of optical fibers are laterally aligned with respect to each other prior to the step of being fixedly attached to the ferrule.

The foregoing and other features of the invention are hereinafter described in greater detail with reference to the accompanying drawings.

### BRIEF DESCRIPTION OF THE DRAWINGS

FIG. 1 is a schematic partial cross-sectional view of a conventional semiconductor optical device package.

FIG. 2 is a schematic cross-sectional view of a conventional ferrule.

FIG. 3 is a schematic top view of an exemplary semiconductor optical device package in accordance with the present invention.

FIG. 4 is a schematic cross-sectional view of an exemplary ferrule in accordance with the present invention.

FIG. 5 is schematic end view of two optical fibers having rotationally and latitudinally aligned optical axes in accordance with the present invention.

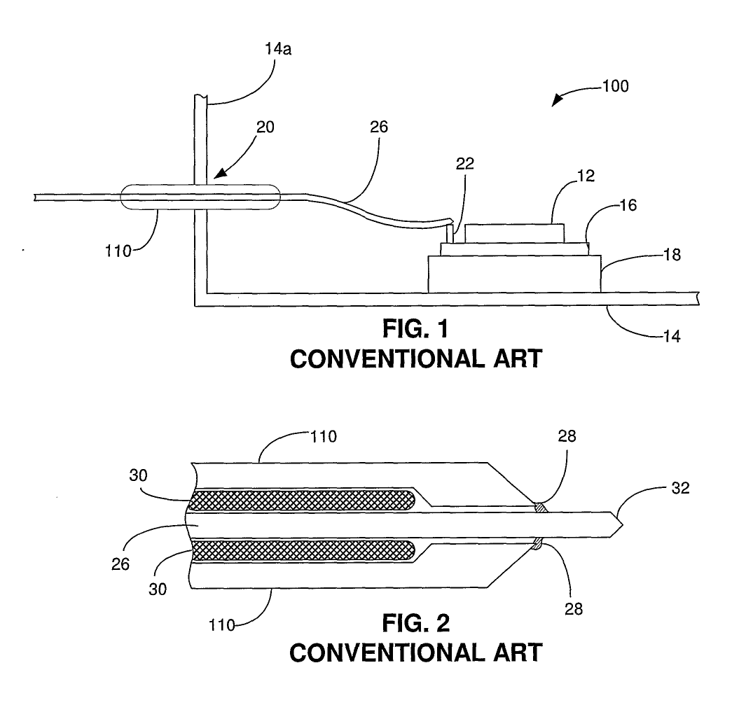

### DESCRIPTION

In the description that follows, like components have been given the same reference numerals, regardless of whether they are shown in different embodiments. To illustrate an embodiment(s) of the present invention in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

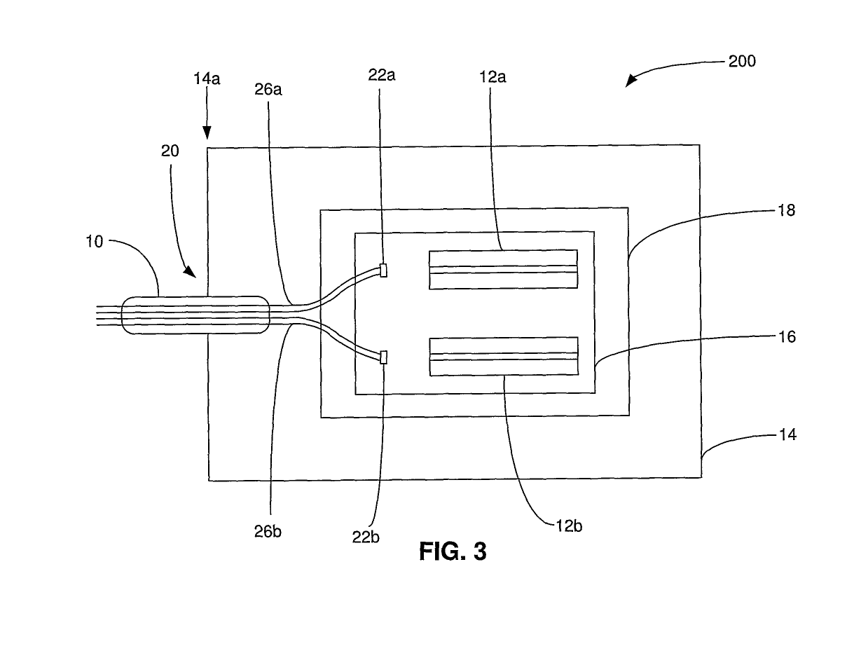

Referring now in detail to the drawings and initially to FIG. 3, an exemplary semiconductor optical device package in accordance with the present invention is shown generally at 200. The package 200 may be optically coupled, for example, to an external optical device (not illustrated) such as, for example, an erbium doped fiber amplifier (EDFA) or Raman amplifier.

The semiconductor optical device package 200 includes two co-packaged semiconductor optical devices 12a and 12b. The semiconductor optical devices are typically semiconductor lasers or photodiodes and are designed for operation independently of each other or in a coordinated way. As illustrated, the semiconductor optical devices 12a and 12b are mounted spaced apart on a single carrier 16. The devices are spaced apart sufficiently to prevent thermal and other cross-talk. In addition, there may be partitioning between the devices or other means inserted or implemented to reduce or eliminate optical cross-talk. The carrier may optionally be mounted upon a TEC 18. In one embodiment, one or both of the semiconductor optical devices 12a and 12b may be a semiconductor laser device such as a pump laser. While the semiconductor optical devices 12a and 12b are illustrated chiefly in this context, it is to be understood that the semiconductor optical devices 12a and 12b may be any suitable semiconductor optical device or combination of devices. For example, one or both of the optical devices 12a and 12b may be a semiconductor photodiode (e.g., avalanche photodiode) for monitoring the performance of the external optical device (e.g., EDFA or Raman amplifier). In such embodiment, electrical connections from the semiconductor photodiode(s) may be made to pins on the outside of the package 200 (e.g., for monitoring purposes). Electrical signals output from the photodiode(s) may be used for controlling the external optical device.

The semiconductor optical devices 12a and 12b may be the same type of device (e.g., both semiconductor lasers) or a different type of device (e.g., one semiconductor laser and one semiconductor photodiode). Furthermore, the semiconductor optical devices 12a and 12b may possess the same, similar, or differing specification and performance. In an embodiment where the semiconductor optical devices 12a and 12b are pump lasers (e.g., for pumping an optical amplifier such as an EDFA, Raman amplifier, etc.), the semiconductor optical devices 12a and 12b may emit a light at the same or approximately the same wavelength. For example, both semiconductor optical devices 12a and 12b may emit light at about 980 nm (9xx nm) or about 1480 nm (145xx nm). But it is contemplated that semiconductor optical device 12a may emit a light at a different wavelength than the light emitted from semiconductor optical device 12b. For example, semiconductor optical device 12a may emit light at about 980 nm (9xx nm) and semiconductor optical device 12b may emit light at about 1480 nm (145xx nm). Of course, the actual wavelength of light emitted from the semiconductor optical devices 12a and 12b may vary. Hence in one embodiment the co-packaged semiconductor lasers may be used to pump one or more types of optical amplifiers (e.g., EDFA, Raman amplifier). In another embodiment the co-packaged semiconductor lasers may be used individually to pump each of the amplification stages of a multi-stage optical amplifier.

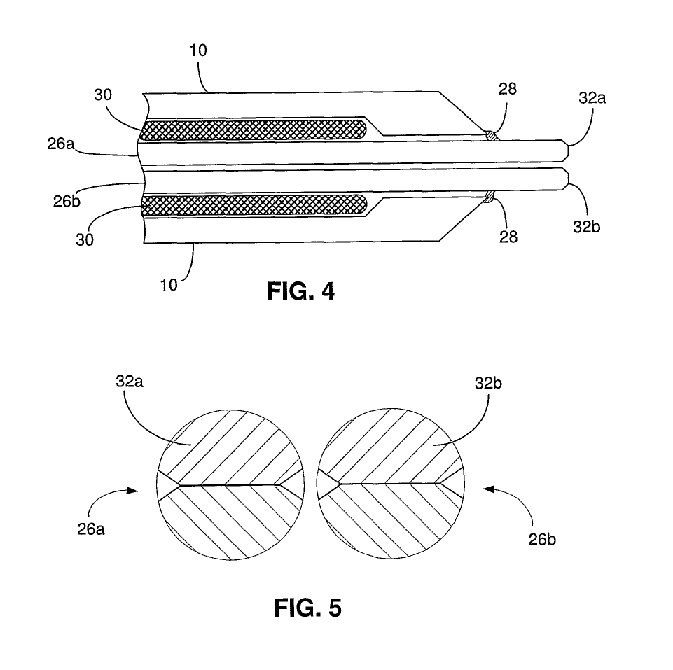

A ferrule 10 is arranged such that it is disposed in a port 20 of a wall 14a of the housing 14. The ferrule 10 is generally tubular in shape. Accordingly, with additional reference to FIG. 4, the ferrule 10 defines an orifice through which a plurality of fibers 26a and 26b may be passed. As illustrated, the orifice of the ferrule 10 may be tapered. The ferrule 10 is fixedly attached, e.g., soldered to the wall 14a.

A plurality of optical fibers 26a and 26b are arranged such that they pass through the ferrule 10 and optically couple the semiconductor optical devices 12a and 12b to the external optical device. The optical fibers 26a and 26b may be the same or different in composition and/or type. For example, one or both optical fibers 26a and 26b may be polarization maintaining (PM) fibers or non-PM fibers. In case of both fibers are PM fibers, the polarization axis of the two fibers can be parallel or orthogonal. One or more of the optical fibers 26a and 26b may also include a Bragg grating.

The optical fibers 26a and 26b are fixedly attached to the ferrule 10 using low melt point glass 28 (or solder in case of metalized fiber), at an end portion of the ferrule, which also serves as a hermetic seal. An epoxy resin 30 fills a portion of the ferrule 10 distal the optical device 12. In an embodiment such as that illustrated in FIG. 4 where the orifice of the ferrule 10 is tapered, the epoxy resin 30 may be filled in at least the tapered portions. Accordingly, the optical fibers 26a and 26b will remain in the same alignment once fixed. Each of the optical fibers 26a and 26b includes an end face 32a and 32b, respectively. In one embodiment, the respective end faces 32a and 32b of the optical fibers 26a and 26b are formed as a lens, e.g., by cleaving and shaping the end of the fiber into a lens. For example, the cleaved ends of the optical fibers 26a and 26b may be shaped into lenses, each lens having at least two focal lengths.

The optical fibers 26a and 26b may be rotationally aligned so that the optical axis of the fibers 26a and 26b and end faces 32a and 32b are aligned in the same or substantially the same direction with respect to each other, as shown in FIG. 5. Typically, the tolerance on the rotational alignment between the optical axes on a pair of fibers sharing the same ferrule is about +/−4°. FIG. 5 further illustrates that the optical axes of the optical fibers 26a and 26b may also be laterally aligned with respect to each other. Typically, the tolerance on the lateral alignment between the optical axes on a pair of fibers sharing the same ferrule is less than 2 um. This alignment is achieved during the assembly of the ferrule component and prior to insertion into the port 20, as described below.

The optical fibers 26a and 26b extend into the housing 14 and a portion of the optical fibers 26a and 26b proximate the end faces 32a and 32b are fixedly attached to respective fixing points 22a and 22b. A curvature may be present in each optical fibers 26a and 26b to allow for stress relief at the end face 32. The end faces 32a and 32b of the optical fibers 26a and 26b are respectively arranged at a longitudinal and rotational position relative to an output/input of the semiconductor optical devices 12a and 12b. In an embodiment where the semiconductor optical devices 12a and 12b are semiconductor lasers, the end faces 32a and 32b are arranged such that an asymmetric optical output field provided by the optical devices 12a and 12b may be coupled into the optical fibers 26a and 26b. For example, where the semiconductor optical devices 12a and 12b are arranged in a parallel arrangement and are all in the same orientation (for example all fast axes in one direction and all slow axes in the orthogonal direction), then the optical axes of the end faces 32a and 32b of the optical fibers 26a and 26b may be orientated such that the equivalent axes of the end faces 32a and 32b are substantially parallel. In such an embodiment, the tolerance on the rotational alignment of the optical fiber fast axis with the semiconductor optical device fast axis may be about +/−2° and the tolerance on the rotational alignment between the fast axes on a pair of optical fibers sharing the same ferrule may be about +/−4°. Of course, if the semiconductor optical devices were not mounted in the package in a coplanar arrangement or in parallel planes, then the relative rotational orientations of fibers in the ferrule could be set accordingly (e.g., relative to the respective rotational orientations of the semiconductor optical devices). Prior to assembly of the package 200, the optical fibers 26a and 26b are passed through the ferrule 10 and the optical axes of the optical fibers 26a and 26b are rotationally and laterally adjusted relative to each other (e.g., as described above and as illustrated in FIG. 5). With reference to FIG. 5, rotational alignment may be achieved, for example, by rotating one or more of the optical fibers 26a and 26b, and lateral alignment may be achieved, for example, by moving one or more of the optical fibers 26a and 26b in an upward or downward manner with respect to each other. The aligned optical fibers 26a and 26b are fixedly attached to the ferrule 10 via the low melting point glass 28, solder, and/or epoxy resin 30. Hence the optical fibers connecting to the semiconductor optical devices are aligned prior to engagement with the light output/input of the co-packaged semiconductor optical devices.

The package 200 is assembled by inserting the combined ferrule 10 and fixed optical fibers 26a and 26b through the port 20 such that the ferrule 10 and the optical fibers 26a and 26b pass through the port 20. The optical fibers 26a and 26b are actively or passively optically coupled with respective outputs/inputs of the semiconductor optical devices 12a and 12b before being glued or otherwise fixed into position at fixing points 22a and 22b. As discussed above, the optical fibers 26a and 26b have been rotationally adjusted with respect to each other prior to being fixed to the ferrule 10 and being inserted through the port 20. Therefore, the combined ferrule 10 and fixed optical fibers 26a and 26b allow for adjustment of the optical fibers 26a and 26b to be performed without rotational adjustment of the optical fibers 26a and 26b and/or ferrule 10, as a predefined alignment of the two optical fibers is performed at the ferrule. The optical fibers 26a and 26b are generally made from a relatively stiff material (e.g., glass, metalized fiber, etc.) and twisting the fibers for adjustment purposes can be difficult or even not possible. Such twisting can generate a large torsion force and result in catastrophic fiber failure. Furthermore, adjustment of the fibers 26a and 26b by rotation of the ferrule 10 can be difficult because of the multiple optical fiber arrangement in the ferrule 10.

The respective end faces 32a and 32b of the optical fibers 26a and 26b may be longitudinally aligned with the respective outputs/inputs of the semiconductor optical devices 12a and 12b, for example, by longitudinally adjusting the ferrule 10 or by adjusting the amount of curve in one or more of the optical fiber 26a and 26b. Once aligned, the portion of the optical fiber 26a and 26b proximate the end faces 32a and 32b are respectively fixed in place with low melting point glass, solder, or epoxy resin at fixing points 22a and 22b. The ferrule 10 is fixedly attached, e.g., soldered, to the wall 14a.

The ferrule 10 in accordance with the invention allows for multiple semiconductor optical devices to be optically coupled to one or more external devices via a single port. As such, the ferrule 10 has been described above in the exemplary arrangement of having two optical fibers 26a and 26b passed therethrough, arranged, and fixedly attached thereto for optically coupling two optical devices co-packaged together on a single substrate. But it is also contemplated that more than two (e.g., three, four, etc.) optical devices may be co-packaged together on a single substrate and that the ferrule may include more than two (e.g., three, four, etc.) optical fibers that are passed therethrough, arranged, and fixedly attached thereto.

Furthermore, an embodiment is contemplated where a plurality of semiconductor optical devices are co-packaged, and where the package includes more than one port and ferrule. In such an embodiment, at least one of the ferrules includes at least two optical fibers. For example, a package may include four semiconductor optical devices co-packaged together on a single substrate and two ferrules, each ferrule including two optical fibers for optically coupling two of the four semiconductor optical devices.

Multiple ferrules may be utilized when more than one type of semiconductor optical device is co-packaged in the package. For example, one ferrule may optically couple a plurality of semiconductor lasers to an external optical device and another ferrule may optically couple a plurality of photodiodes to the external optical device. Although the photodiodes may be packaged together outside the package 200, it is advantageous to incorporate them into the same package as the semiconductor optical devices 12a and 12b because the photodiodes benefit from the stable and hermetic environment of the package. The photodiodes may be mounted on the same carrier as the semiconductor lasers or may have a separate mounting arrangement within the same package. Inclusion of the photodiodes in the package allows for a reduction in the number of packages associated with an external optical device such as an optical amplifier. In fact, just one package of active semiconductor devices may be associated with an external optical device.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A semiconductor optical device package, including:
a plurality of semiconductor optical devices disposed within a housing;
a port arranged on a wall of the housing;
a ferrule fixedly disposed in the optical outlet port; and
a plurality of optical fibers passed through and fixedly attached to the ferrule, the plurality of optical fibers being respectively optically coupled to the plurality of semiconductor optical devices.

2. The semiconductor optical device package of claim 1, wherein optical axes of the plurality of optical fibers are rotationally aligned with respect to each other.

3. The semiconductor optical device package of claim 2, wherein a tolerance on the rotational alignment between the optical axes of the plurality of optical fibers is about +/−4°.

4. The semiconductor optical device package of claim 1, wherein optical axes of the plurality of optical fibers are laterally aligned with respect to each other.

5. The semiconductor optical device package of claim 4, wherein a tolerance on the lateral alignment between the optical axes of the plurality of optical fibers is less than about 2 μm.

6. The semiconductor optical device package of claim 1, wherein the plurality of optical fibers are fixedly attached to the ferrule using at least one of low melt point glass, solder, and epoxy resin.

7. The semiconductor optical device package of claim 1, wherein the plurality of optical fibers optically couple the plurality of semiconductor optical devices to at least one of an EDFA amplifier and a Raman amplifier.

8. The semiconductor optical device package of claim 1, wherein the semiconductor optical devices are at least one of semiconductor lasers, semiconductor photodiodes, and at least one semiconductor laser and at least one semiconductor photodiode.

9. The semiconductor optical device package of claim 1, wherein at least one of the semiconductor optical devices emits light at a wavelength of at least one of about 980 nm and about 1480 nm.

10. A ferrule for being fixedly disposed in the optical outlet port of a semiconductor optical device package, including:
an orifice through which a plurality of optical fibers pass through, the plurality of optical fibers being fixedly attached to the ferrule.

11. The ferrule of claim 10, wherein optical axes of the plurality of optical fibers are rotationally aligned with respect to each other.

12. The ferrule of claim 11, wherein a tolerance on the rotational alignment between optical axes of the plurality of optical fibers is about +/−4°.

13. The ferrule of claim 10, wherein optical axes of the plurality of optical fibers are laterally aligned with respect to each other.

14. The ferrule of claim 13, wherein a tolerance on the lateral alignment between the optical axes of the plurality of optical fibers is less than about 2 μm.

15. The ferrule of claim 10, wherein the plurality of optical fibers is fixedly attached to the ferrule using at least one of low melt point glass, solder, and epoxy resin.

16. A method of manufacturing semiconductor optical device package, including:
inserting a ferrule and a plurality of optical fibers passed through and fixedly attached to the ferrule through a port arranged on a wall of a housing;
optically coupling the plurality of optical fibers to a plurality of semiconductor optical devices disposed within the housing; and
fixedly attaching the ferrule to the wall of the housing.

17. The method of claim 16, wherein the plurality of optical fibers are passed through and fixedly attached to the ferrule prior to the step of inserting the ferrule and the plurality of optical fibers through the port.

18. The method of claim 17, wherein optical axes of the plurality of optical fibers are rotationally aligned with respect to each other prior to the step of being fixedly attached to the ferrule.

19. The method of claim 17, wherein optical axes of the plurality of optical fibers are laterally aligned with respect to each other prior to the step of being fixedly attached to the ferrule.

20. The method of claim 16, wherein the plurality of optical fibers optically couple a plurality of semiconductor optical devices to at least one of an EDFA amplifier and a Raman amplifier.

21. The method of claim 16, wherein the semiconductor optical devices are at least one of semiconductor lasers, semiconductor photodiodes, and at least one semiconductor laser and at least one semiconductor photodiode.
